(19) United States
(12) Patent Application Publication
(10) Pub. No.: US 2013/0168202 A1
(43) Pub. Date: Jul. 4, 2013

(54) FOUNTAIN-PEN AUTOMATIC ASSEMBLY LINE

(71) Applicant: Beifa Group Co., Ltd., Ningbo (CN)

(72) Inventors: Cailiang Dong, Ningbo (CN); Feng Zhu, Ningbo (CN)

(73) Assignee: BEIFA GROUP CO., LTD., Ningbo (CN)

(21) Appl. No.: 13/720,765

(22) Filed: Dec. 19, 2012

(30) Foreign Application Priority Data
Dec. 29, 2011 (CN) 201110449557.X

(51) Int. Cl. B65G 17/12

(52) U.S. Cl. CPC B65G 17/12
USPC 198/339.1

(57) ABSTRACT

A fountain-pen automatic assembly line system includes a worktable, two sprockets, and an endless loop driving chain connecting the two sprockets. The sprockets are mounted at two ends of the worktable respectively. A plurality of jigs is provided on the driving chain, wherein the jigs are configured to hold fountain pen barrels. A transporting rail supporting the driving chain is provided between the two sprockets, and the transporting rail is fixed on the worktable. An ink-reservoir mounting station and an ink-reservoir pressing station are provided on the worktable successively. The ink-reservoir mounting station is provided with an automatic ink-reservoir mounting machine, and the ink-reservoir pressing station is provided with an automatic ink-reservoir pressing machine. The ink-reservoir mounting process and the ink-reservoir pressing process are linked via the driving chain, so that the assembly time is shortened and the assembly efficiency is improved.

### TECHNICAL FIELD

Embodiments of the present disclosure relate to an assembly line system, and in particular a fountain-pen automatic assembly line system.

### BACKGROUND

A conventional assembly procedure for a fountain pen is mainly in the form of an assembly line where different parts of the pen are assembled in different, physically separated assembly processes. The assembly procedure of fountain pens mainly includes a process of filling ink into pen barrels, an ink-reservoir mounting process, an ink-reservoir pressing process, a pen-cap mounting process, a pen-cap pressing process, and the like. In a conventional fountain-pen assembly procedure, the different processes are completed at different, physically separated worktables. The ink-reservoir mounting process employs a pneumatic press machine, and an operator fixes the pen barrel filled with ink under the press machine, mounts the ink reservoir into the pen barrel, and then starts the pneumatic press machine to press the ink reservoir into the pen barrel. The process is labor intensive and inefficient. If the operator becomes careless, the pneumatic press machine may cause injury to his/her hand. In a conventional assembly procedure, each process needs at least one operator further adding to the inefficiency. Furthermore, when one process has been completed, it is necessary to transfer the semi-assembled products to a different and physically separated worktable to continue the assembly process. Because the semi-assembled products are transferred manually, not only is the assembly efficiency very low, but it is also easy for the semi-assembled products to be damaged during transferring. As a result, material is wasted.

### SUMMARY

In various embodiments, an assembly line system is disclosed. The assembly line system includes a worktable; a first sprocket positioned on a first side of the worktable, and a second sprocket positioned on a second, opposite side of the worktable; a chain connecting the two sprockets; and a plurality of jigs provided on the chain, wherein the jigs are configured to receive pen barrels. The assembly line system includes an ink-reservoir mounting station and an ink-reservoir pressing station provided on the worktable successively. The ink-reservoir mounting station includes an automatic ink-reservoir mounting machine, and the ink-reservoir pressing station includes an automatic ink-reservoir pressing machine.

The automatic ink-reservoir mounting machine and the automatic ink-reservoir pressing machine can be provided on the same worktable and along the same chain for efficiency.

The automatic ink-reservoir mounting machine includes a vibratory bowl feeder that connects to an upright transporting pipe that is used to place ink reservoirs within a pen barrel held on a jig on the chain.

The automatic ink-reservoir mounting machine may include a loading jig that is horizontally positionable in a first and a second position. The first position of the loading jig is below the upright transporting pipe, and the second position is between a vertically movable shaft above and a jig on the chain below.

The loading jig may include a hole that aligns beneath the transporting pipe in the first position, and the hole is aligned with and between the vertically movable shaft and a jig on the chain.

The loading jig is connected to a cylinder that moves the loading jig from the first position to the second position and returns the jig to the first position.

The loading jig receives an ink reservoir, or cartridge, from the transporting pipe in the first position, and the movable shaft pushes the ink reservoir from the loading jig to a pen barrel carried by the jig in the second position.

The assembly line system may further include a feeding station and an ink-filling station in succession on the worktable and upstream of the ink-reservoir mounting station. The assembly line system may also include a pen-cap mounting station, a pen-cap pressing station, and a cropping station in succession downstream of the ink-reservoir pressing station, wherein each station is provided along the same worktable and chain.

The feeding station may include an automatic feeding machine; the ink-filling station may include an automatic ink-filling machine; the pen-cap pressing station may include an automatic pen-cap pressing machine; and the cropping station may include an automatic cropping machine.

The automatic cropping machine may include a clamping assembly having a first cylinder with a first cylinder shaft, and a second cylinder with a second cylinder shaft, wherein the first and the second cylinder shafts are facing each other. A space between the first and the second cylinder shafts is above a jig on the chain of the worktable.

The clamping assembly is coupled to a third cylinder that moves the clamping assembly from above the jigs to an area clear of the jigs to deposit pens in a receiving area.

The assembly line system may include a programmable logic controller (PLC) such that the sprockets, the automatic feeding machine, the automatic ink-filling machine, the automatic ink-reservoir mounting machine, the automatic ink-reservoir pressing machine, the automatic pen-cap pressing machine, and the automatic cropping machine are connected to the PLC controlling module. The automatic feeding machine, the automatic ink-filling machine, the automatic ink-reservoir mounting machine, the automatic ink-reservoir pressing machine, the automatic pen-cap pressing machine, and the automatic cropping machine can each be provided with a photoelectric sensing device.

The assembly line system disclosed herein may be specifically related to the assembly of fountain pens. A “fountain” pen as used herein includes any of the various types of writing instruments that may include consumer-refillable ink reservoirs, such as cartridges, or are refillable via various refilling means. A fountain pen generally includes a barrel and pen cap forming the exterior; an ink reservoir, such as a cartridge or a rubber sack within the barrel; a point or nib that contacts the paper; and a feed section. There are various types of mechanisms for refilling the ink reservoir, such as a lever filler. However, other mechanisms are possible. Additionally, some fountain pens may include disposable plastic cartridges. Thus, the ink reservoir is discarded after the ink is depleted. These plastic cartridges are initially sealed. A consumer will place a plastic cartridge within a pen barrel and the feed section will be used to puncture an end of the cartridge to allow the ink to flow to the pen tip. Other variations of fountain pens are ascertainable by those skilled in the art.

Because the ink-reservoir mounting station and the ink-reservoir pressing station are provided on the worktable successively, the ink-reservoir mounting process and the ink-reservoir pressing process can be completed on the same worktable. These two processes may be linked via the driving chain, so that the assembly time is shortened and the assembly efficiency is improved. Furthermore, the ink-reservoir mounting station can be provided with an automatic ink-reservoir mounting machine, and the ink-reservoir pressing station can be provided with an automatic ink-reservoir pressing machine. Therefore, because automatic operation is employed, labor can be reduced, and assembly efficiency can be increased.

When the feeding station, the ink-filling station, the pen-cap mounting station, the pen-cap pressing station and the cropping station are provided on the worktable successively, and the ink-reservoir mounting station and the ink-reservoir pressing station are located between the ink-filling station and the pen-cap mounting station, each station is linked via the driving chain so that an assembly line system is formed on the same worktable. Therefore, labor is reduced and the assembly efficiency is increased.

When the feeding station is provided with an automatic feeding machine, the ink-filling station is provided with an automatic ink-filling machine, the pen-cap pressing station is provided with an automatic pen-cap pressing machine, and the cropping station is provided with an automatic cropping machine, the feeding station, the ink-filling station, the ink-reservoir mounting station, the ink-reservoir pressing station, the pen-cap pressing station and the cropping station can all be operated automatically, so the assembly efficiency is very high. In at least one embodiment, the whole assembly procedure has seven stations, but only requires one operator who is responsible for the pen-cap mounting station, thus, reducing the amount of labor that is needed.

When the automatic ink-filling machine, the automatic ink-reservoir mounting machine, the automatic ink-reservoir pressing machine, the automatic pen-cap pressing machine, and the automatic cropping machine are each provided with a photoelectric sensing device, these photoelectric sensing devices monitor whether the previous process was missed or not. If it is detected that a pen missed the previous process, the automatic ink-filling machine, the automatic ink-reservoir mounting machine, the automatic ink-reservoir pressing machine, the automatic pen-cap pressing machine, or the automatic cropping machine can suspend operation until it is detected that a pen has gone through the previous process. Therefore, an unnecessary operation of the automatic ink-filling machine, the automatic ink-reservoir mounting machine, the automatic ink-reservoir pressing machine, the automatic pen-cap pressing machine, and the automatic cropping machine can be avoided. The operation accuracy and the life of the machines can be improved.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 schematically shows the structure of a fountain pen assembly line system;

FIG. 2A schematically shows the structure of the automatic ink-reservoir mounting machine in one position;

FIG. 2B schematically shows the structure of the automatic ink-reservoir mounting machine in a second position;

FIG. 3 schematically shows the structure of the automatic ink-reservoir pressing machine;

FIG. 4 schematically shows the structure of a fountain pen assembly line system;

FIG. 5 schematically shows the structure of an automatic cropping machine;

FIG. 6 schematically shows the structure of an automatic pen-cap pressing machine;

FIG. 7 schematically shows the structure of an automatic feeding machine; and

FIG. 8 schematically shows the structure of an automatic ink-filling machine.

### DETAILED DESCRIPTION

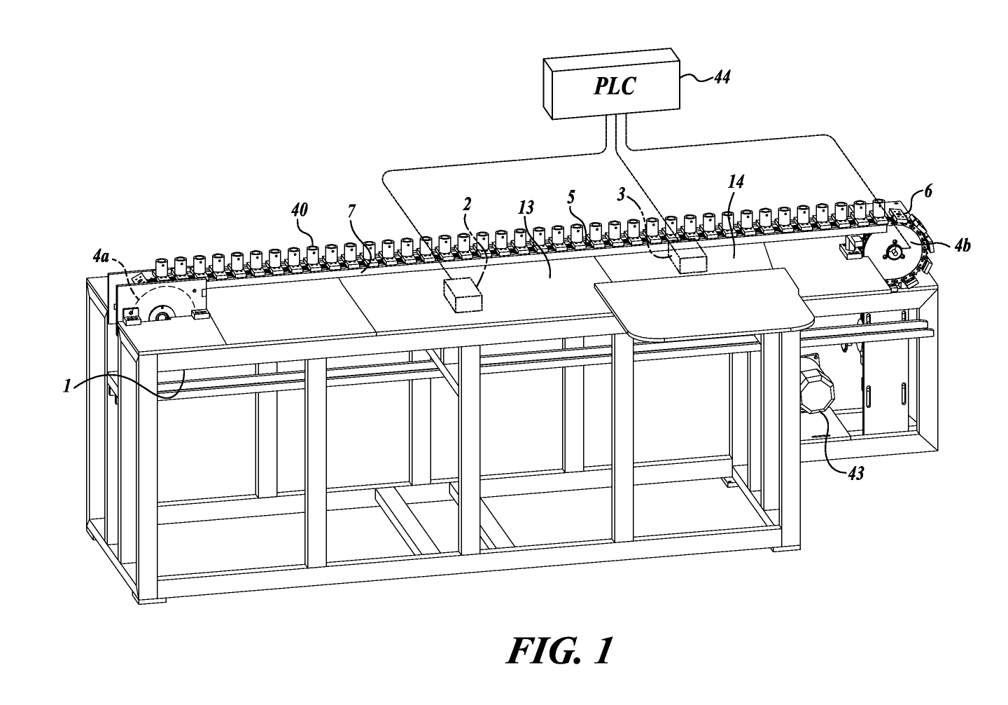

With reference to FIG. 1, at least one embodiment of a fountain-pen automatic assembly line system includes a worktable 1, two sprockets 4a and 4b, and an endless loop driving chain 5 connecting the two sprockets 4a and 4b. As used herein, “automatic” may mean an operation performed wholly or partly by machine. The two sprockets 4a and 4b are mounted at the two opposite ends of the same worktable 1, respectively. One sprocket may be a drive sprocket, while the second sprocket may be an idler sprocket. The drive sprocket, for example, sprocket 4b, may be driven to rotate by electrical motor 43. In this case, the sprocket 4a is the idler sprocket. However, the drive sprocket may be sprocket 4a and the idler sprocket can be sprocket 4b.

A plurality of jigs 6 are provided on a plurality of links of the chain 5, with one jig for each link, for example. A jig 6 is configured to receive empty pen barrels 40 in the feeding process. A jig 6 may include a generally flat member with a hole sized to snugly receive a pen barrel 40. The driving chain 5 transfers the jigs 6 and, thus, pen barrels 40 from left to right in the figure. A transporting rail 7 supporting the driving chain 5 is provided between the two sprockets 4a, 4b. The transporting rail 7 is fixed on the worktable 1.

An ink-reservoir mounting station 13 and an ink-reservoir pressing station 14 are provided on the same worktable 1 successively. The ink-reservoir mounting station 13 can be provided with an automatic ink-reservoir mounting machine 2 in proximity to the chain 5, and the ink-reservoir pressing station 14 can be provided with an automatic ink-reservoir pressing machine 3 in proximity to the chain 5. A “station” as used herein is a mechanism provided on the worktable 1 or along the chain 5 for performing an assembly process. In some embodiments, a station is simply an area where the process is performed manually, i.e., by a human operator. In some embodiments, a station may have a machine that can fully or partially perform the process.

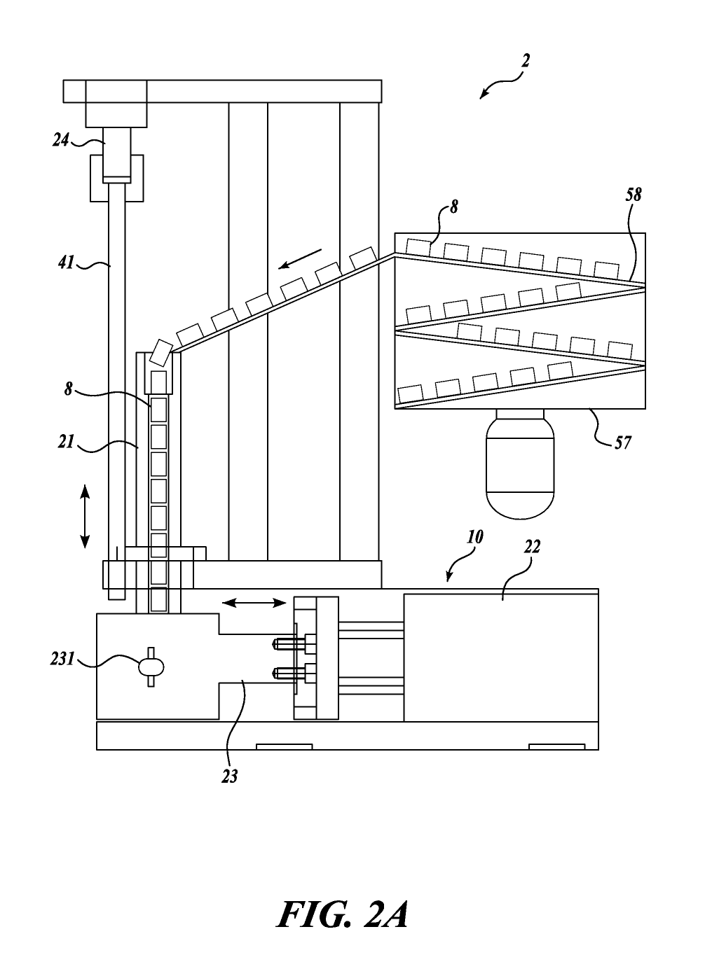

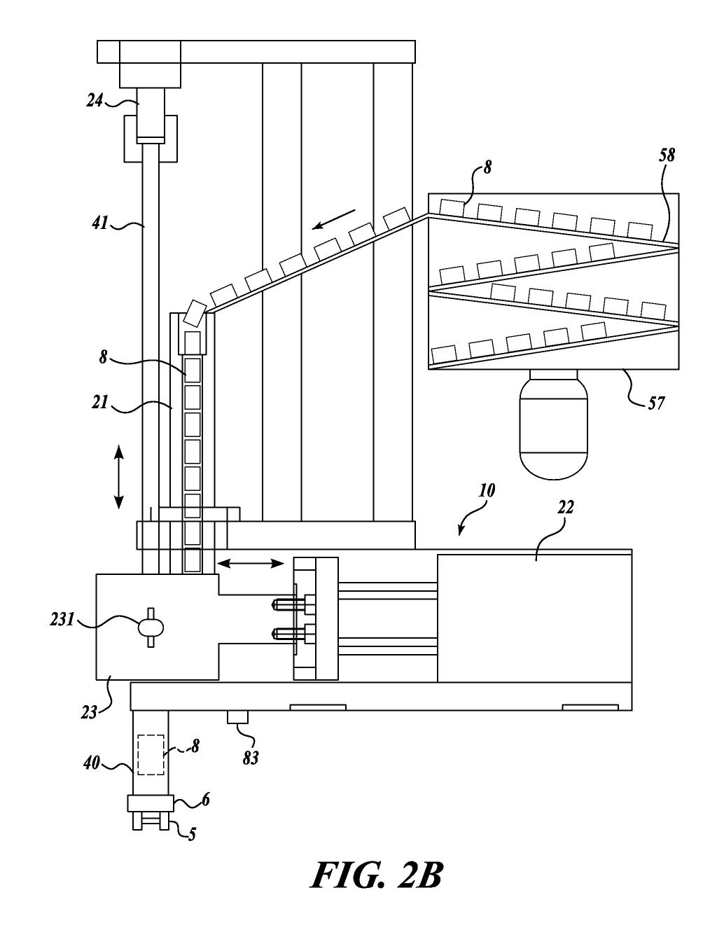

As shown in FIG. 2, the automatic ink-reservoir mounting machine 2 includes a vibratory bowl feeder 57, a transporting pipe 21, and a mounting mechanism 10.

The vibratory bowl feeder 57 may include a motor and a bowl 57. The vibratory bowl feeder may have a helical track 58 on the inside of the bowl 57. The specifics of the track 58 are designed for the particular application. The motor causes vibration, and the parts 8, in this case ink reservoirs 8 or cartridges, are transported upwards in the helical track 58 and around the bowl 57 due to the vibrating action. The vibratory bowl feeder 57 is in communication with and feeds the ink reservoirs 8 to the upright transporting pipe 21.

The mounting mechanism 10 includes an assembly containing a first cylinder 22, a loading jig 23, and a second cylinder 24. As used herein, a “cylinder” may refer to a pneumatically—operated cylinder. In at least one embodiment, the basic construction of such cylinders includes a chamber fitted with a piston that connects with a shaft outside of the cylinder. When pressurized air is introduced into the cylinder chamber behind the piston, the air drives the piston and the shaft outwards. This action causes the piston to push against a spring, and when the air pressure is released from the chamber, the spring drives the piston and shaft inwards within the chamber. However, different constructions are possible, such as electrically operated solenoids.

The first cylinder 22 is used for moving the loading jig 23 horizontally between a first and a second position. The cylinder shaft of the first cylinder 22 is connected with one end of the loading jig 23, and the other end of the loading jig 23 is provided with the loading hole 231. The hole 231 extends vertically through the loading jib 23 from top to bottom. In FIG. 2A, the loading jig 23 is positioned such that the hole 231 is in alignment with the transporting pipe 21, and the loading jig 23 is ready to receive an ink reservoir 8 via gravity.

Referring now to FIG. 2B, the first cylinder 22 has extended the shaft to move the loading jig 23, and specifically the hole 231, to a new position below the second cylinder 24. The loading jig in FIG. 2B is moved from under the transporting pipe 21 to under the shaft 41 connected to the cylinder 24. Below the loading jig 23, the chain 5 has transported a jig 6 carrying a pen barrel 40 directly underneath the loading jig 23 such that the hole 231 becomes aligned with both the pen barrel 40 below and the shaft 41 above. Once a pen barrel 40 receives an ink reservoir 8, the chain 5 advances to move the pen barrel 40 to the ink-reservoir pressing station, and particularly, below the ink-reservoir pressing machine 3.

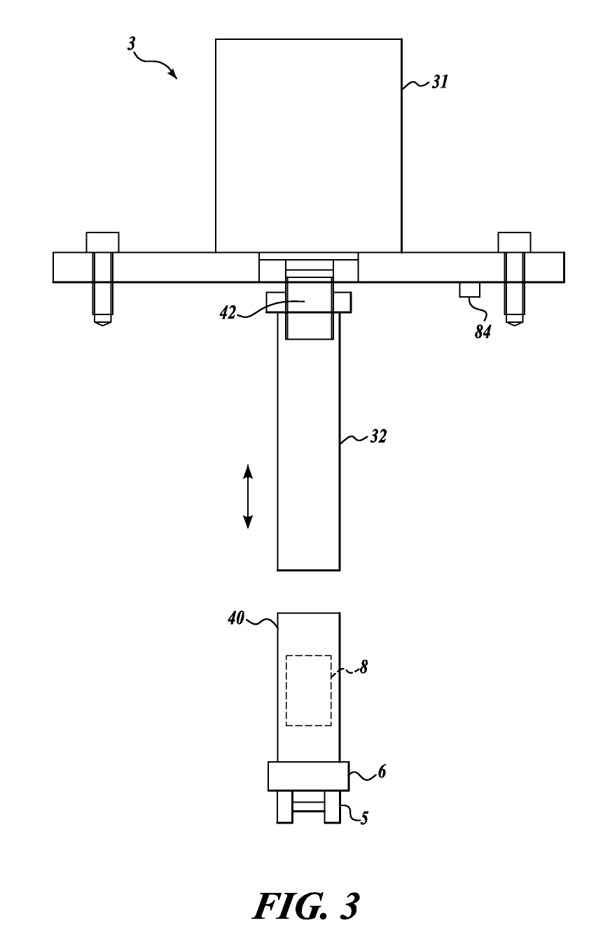

As shown in FIG. 3, the automatic ink-reservoir pressing machine 3 includes a third cylinder 31 and a compression connector 32, and the cylinder shaft of the third cylinder 31 is connected with the compression connector 32. The automatic ink-reservoir pressing machine 3 is arranged along and in proximity of the chain 5 so as to be in alignment with the jigs 6 carrying pen barrels 40. Particularly, the chain 5 transports the pen barrels 40 directly in alignment with the compression connector 32.

When assembling a fountain pen by way of the fountain pen automatic assembly line system of the present embodiment, a single feeding operator and a single receiving operator may be needed. The feeding operator is responsible for mounting the fountain pen filled with ink into the jigs 6. The sprockets 4 transfer the chain 5 and jigs 6 from left to right in the figures, and when the jigs 6 pass by the ink-reservoir mounting station 13, the automatic ink-reservoir mounting machine 2 mounts the ink reservoir 8 into the pen barrel 40.

With reference to FIGS. 2A and 2B, the operating principle of the automatic ink-reservoir mounting machine 2 is as follows. The vibratory bowl feeder 57 vibrates to transfer ink reservoirs 8 upwards along the helical track 58. The ink reservoirs 8 are fed into the upright transporting pipe 21, and a single ink reservoir 8 is allowed to slide into the loading hole 231 of the loading jig 23. Next, with reference to FIG. 2B, the first cylinder 22 pushes the loading jig 23 forward by extending the cylinder shaft in order to locate the ink reservoir 8 in the loading hole 231 below the cylinder shaft 41 of the second cylinder 24 and above a waiting pen barrel 40 which has been carried by a jig 6 on the chain 5. The automatic ink-reservoir mounting machine 2 may include a photoelectric sensing device 83 in order to detect when a pen barrel 40 is correctly positioned below the loading jig 23. As the hole 231 extends vertically from top to bottom, the shaft 41 may push an ink reservoir 8 held in the hole 231 into the waiting pen barrel 40. The second cylinder 24 extends the cylinder shaft 41 downwards and pushes the ink reservoir 8 into the pen barrel 40. The automatic ink-reservoir mounting machine 2 then resets by moving the shaft 41 upwards, and moving the loading jig 23 backwards to the position shown in FIG. 2A in preparation for receiving the next ink reservoir 8. As the loading jig 23 is retracted to the first position shown in FIG. 2A, the chain 5 may incrementally or continuously advance a new jig 6 and pen barrel 40 in anticipation of receiving the next ink reservoir 8. The automatic ink-reservoir mounting machine 2 may adjust the direction of the ink reservoir 8 by means of the characteristic of the helical track in order to enable the ink reservoir 8 to enter the transporting pipe 21 smoothly.

When the chain 5 transfers a pen barrel 40 with an ink reservoir 8 therein by the ink-reservoir pressing station 14, the automatic ink-reservoir pressing machine 3 presses the ink reservoir 8 in position. The automatic ink-reservoir pressing machine 3 may include a photoelectric sensing device 84 to detect when a pen barrel 40 is directly below the compression connector 32. The third cylinder 31 extends the compression connector 32 downward, and the compression connector 32 presses the ink reservoir 8 in position in the pen barrel 40 and then resets by being retracted upward to await the next pen barrel 8. The semi-assembled fountain pen may be received in the transferring box by the receiving operator, and is then transferred to the next process.

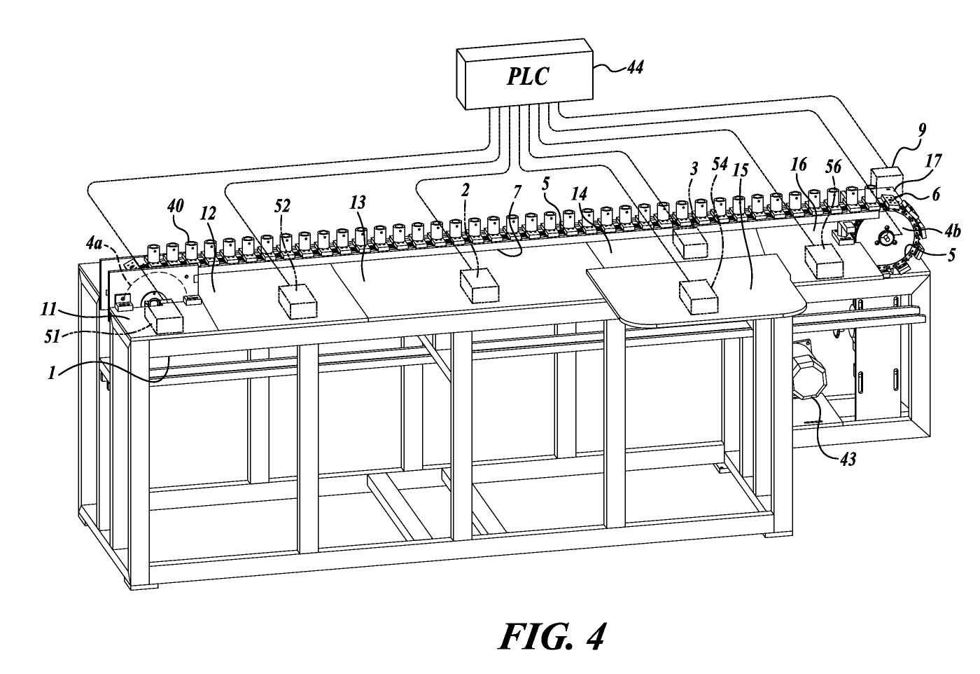

As shown in FIG. 4, an assembly line system of another embodiment is substantially similar to that of the embodiment of FIGS. 1-3 except as described below. A feeding station 11 and an ink-filling station 12 are provided in succession upstream of the ink-reservoir mounting station 13. A pen-cap mounting station 15, a pen-cap pressing station 16, and a cropping station 17 are provided in succession downstream of the ink-reservoir pressing station 14. The feeding station 11 is provided with an automatic feeding machine 51, the ink-filling station 12 is provided with an automatic ink-filling machine 52, the pen-cap pressing station 16 is provided with an automatic pen-cap pressing machine 56, and the cropping station 17 is provided with an automatic cropping machine 9.

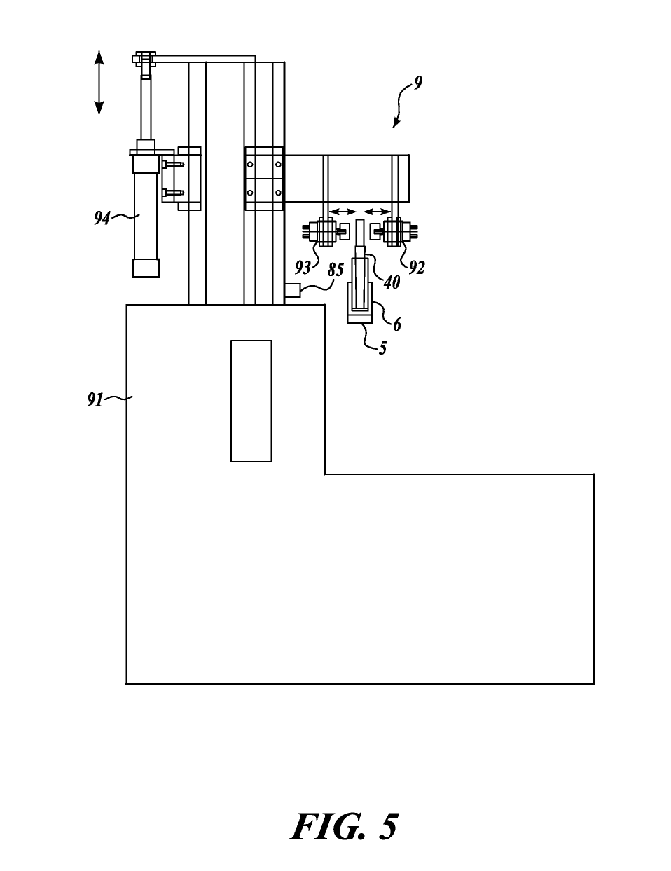

As shown in FIG. 5, the automatic cropping machine 9 includes a cylinder bracket 91, a fourth cylinder 92, a fifth cylinder 93, and a sixth cylinder 94. The fourth and the fifth cylinders 92, 93 are mounted on a beam cantilevered over the chain 5 with jigs 6. The fourth and the fifth cylinders 92, 93 are directly opposite from each other, such that the cylinder shafts of the fourth and the fifth cylinders 92, 93 face each other and can extend toward each other when activated. The fourth and fifth cylinders 92 and 93 may comprise a clamping assembly to pick pen barrels 40 from their respective jigs 6. The fourth cylinder 92 and the fifth cylinder 93 comprising the clamping assembly are coupled with the cylinder shaft of the sixth cylinder 94 via the cantilevered beam to move in unison.

The automatic cropping machine 9 is located at one side of the sprocket 4b. The pen 40 in the jig 6 is designed to travel between the fourth and the fifth cylinders 92, 93. When the fountain pen 40 with pressed pen cap passes between the fourth cylinder 92 and the fifth cylinder 93, the sixth cylinder 94 pushes the fourth cylinder 92 and the fifth cylinder 93 forwards, and the cylinder shafts of the fourth cylinder 92 and the fifth cylinder 93 extend simultaneously and clamp the fountain pen 40 with pressed pen cap. Then, the sixth cylinder 94 pulls the fourth cylinder 92 and the fifth cylinder 93 backwards in unison to a position above the receiving box and clear of the chain 5. The cylinder shafts of the fourth cylinder 92 and the fifth cylinder 93 reset to the unclamped position and the fountain pen falls into the receiving box. The sixth cylinder 94 pushes the fourth cylinder 92 and the fifth cylinder 93 forwards to await the next pen barrel, and the next cycle starts. The automatic cropping machine 9 may include a photoelectric sensing device 85 that can detect the presence of a pen barrel 40 arriving in the position directly between the fourth cylinder 92 and the fifth cylinder 93.

In this embodiment, the pen-cap mounting station 15 may be operated manually or automatically by way of a machine. The automatic feeding machine, the automatic ink-filling machine, and the automatic pen-cap pressing machine are described below. The automatic pen-cap mounting machine may employ machines available in the art.

When assembling fountain pens by way of the fountain-pen automatic assembly line system of the present embodiment, if the pen-cap mounting station 15 is operated manually, two operators are needed. One operator beside the automatic feeding machine may feed stock and arrange the semi-assembled fountain pens in the receiving box while the other operator is responsible for mounting the pen caps. If the pen-cap mounting station 15 is operated automatically, only one operator is needed beside the automatic feeding machine to feed stock and arrange the fountain pens in the receiving box. Each of the processes may employ an automatic operation rendering the assembling efficiency very high.

In the above two embodiments, the sprockets 4a, 4b, the automatic feeding machine 51, the automatic ink-filling machine 52, the automatic ink-reservoir mounting machine 2, the automatic ink-reservoir pressing machine 3, the automatic pen-cap pressing machine 56, and the automatic cropping machine 9 may all be controlled via a programmable logic controller (PLC) controlling module 44. Furthermore, the automatic feeding machine 51, the automatic ink-filling machine 52, the automatic ink-reservoir mounting machine 2, the automatic ink-reservoir pressing machine 3, the automatic pen-cap pressing machine 56, and the automatic cropping machine 9 may all be provided with a photoelectric sensing device. The photoelectric sensing devices may be employed to monitor whether a previous process is completed, and if a previous process has been missed, the automatic ink-filling machine 52, the automatic ink-reservoir mounting machine 2, the automatic ink-reservoir pressing machine 3, the automatic pen-cap pressing machine 56, or the automatic cropping machine 9 will suspend operation. When it is detected that the previous missed process has been completed, the remaining processes may continue.

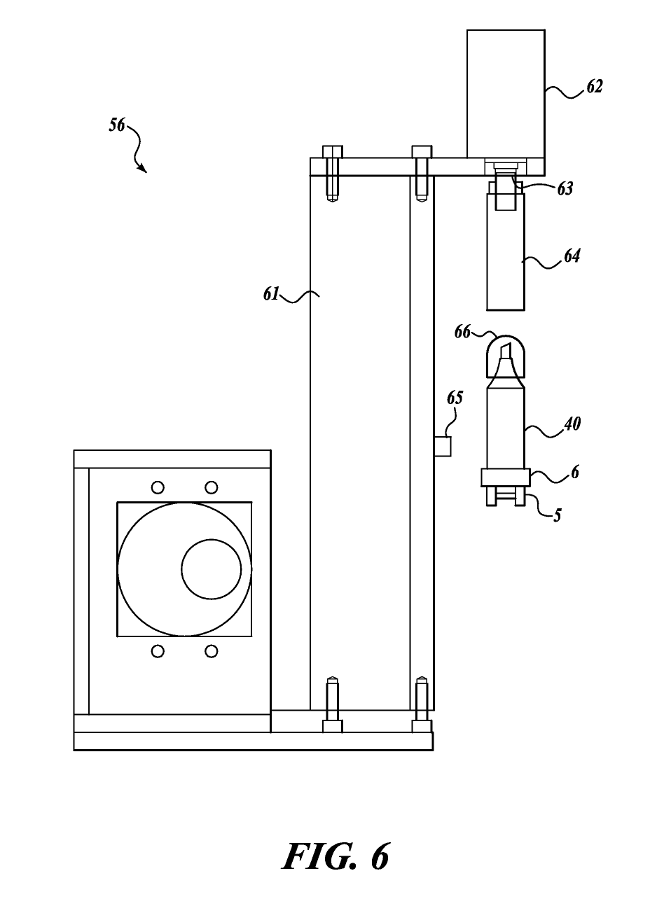

As shown in FIG. 6, the automatic pen-cap pressing machine 56 includes a frame 61, a seventh cylinder 62, and a pressing rod 64. The seventh cylinder 62 is fixed on the frame 61, and the pressing rod 64 is fixed on the cylinder shaft 63 of the seventh cylinder 62. Specifically, the frame 61 is upright and a cantilevered beam is attached horizontally to the top surface of the frame 61. The seventh cylinder 62 is mounted at the cantilevered end of the horizontal beam, such that the shaft 63 is directed in a downward position. The seventh cylinder 62 is placed over the cantilevered end of the horizontal beam in order to allow space for the chain 5 to pass underneath the pressing rod 64.

As shown in FIG. 6, the chain 5 supports a jig 6 carrying a pen barrel 40. The pen barrel 40 has been fitted with a pen cap 66. The pen cap 66 has been mounted on top of the pen barrel 40. The pen-cap pressing machine 56 is located in proximity to the chain 5, such that the pressing rod 64 is directly above and in line with the jigs 6 holding the pen barrels 40. In this manner, the pressing rod 64 can accurately press the cap 66 onto the pen barrel 40. In some embodiments, the pen cap 66 may be rotated to screw the pen cap on the pen barrel 40. The pressing rod 64 is adapted for the particular style of pen barrel. The frame 61 may also include a photoelectric sensing device 65 that detects the presence and absence of a pen barrel 65.

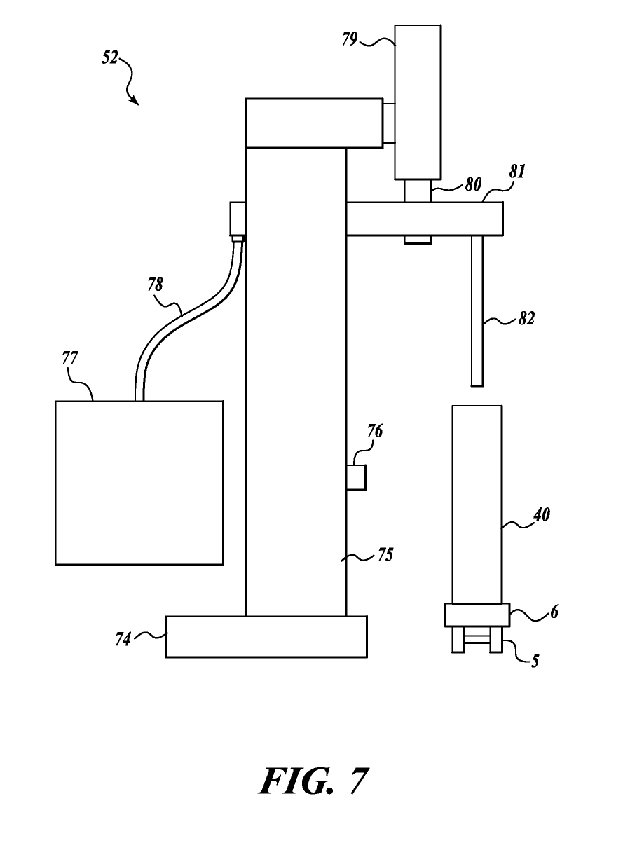

FIG. 7 is a schematic illustration of an automatic ink-filling machine 52. The ink-filling machine 52 is placed in proximity to the chain 5. The ink-filling machine 52 includes a frame 75. The lower end of frame 75 rests on a support base 74. The upper end of the frame 75 includes a cantilevered beam. The cantilevered beam supports an eighth cylinder 79. The eighth cylinder 79 includes a cylinder shaft 80 connected to an ink-filling arm 81. The ink-filling arm 81 includes an ink-filling needle 82 on a cantilevered end thereof. This construction allows room for the chain 5 and jigs 6 with pen barrels 8 to pass underneath and be directly in line below the ink-filling needle 82. The ink to be delivered to the pen 8 is stored in the ink storage tank 77. The ink storage tank 77 includes a pump to pump the ink through the hose 78 connected to one end of the ink-filling arm 81.

In operation, the jigs 6 are carried on the chain 5 with the pen barrels 40 therein and pass underneath the ink-filling needle 82. The eighth cylinder 79 operates to lower the ink-filling arm 81 with needle 82 into the pen barrel 40. In at least one embodiment, a photoelectric sensing device 76 may detect the arrival and departure of a pen barrel 8 from the ink-filling machine 52. The photoelectric sensing device 76 can signal when a pen barrel 40 is underneath the ink-filling needle 82. When the photoelectric detector 76 detects a pen barrel 40, the eighth cylinder 79 is activated and lowers the ink-filling arm 81 so that the ink-filling needle 82 is lowered inside of the pen barrel 40. The pump is turned on and a predetermined amount of ink flows from the ink storage tank 77 through the hose 78 and into the ink-filling needle 82. As the pen barrel 40 is filled with ink, the cylinder 79 raises the ink-filling arm 81 while releasing ink to fill the pen barrel 40.

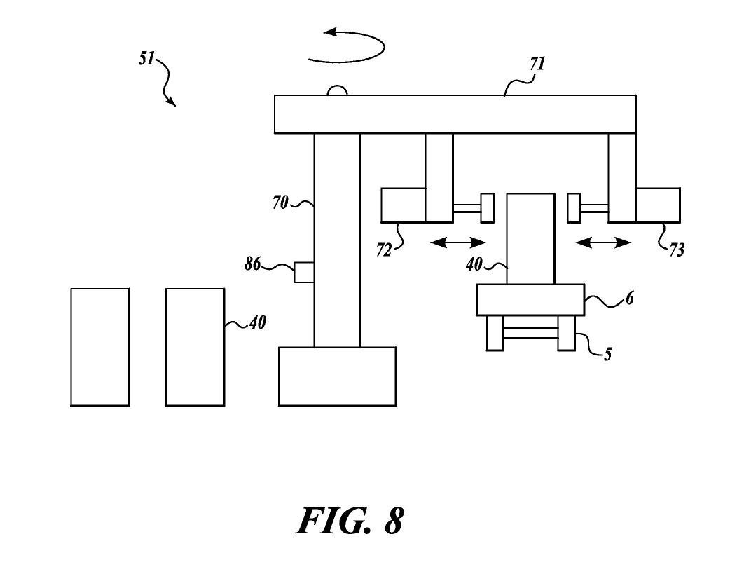

FIG. 8 is a schematic illustration of the pen-barrel feeding machine. The automatic feeding machine includes a base 70 secured alongside the chain 5 carrying the jigs 6. In one embodiment, the automatic feeding machine may include a swinging arm 71 that travels between a first position and a second position. In the first position, the swinging arm 71 may position a ninth cylinder 72 and a tenth cylinder 73 between a pen barrel 40 in a stock holding area. When the swinging arm 71 detects an empty pen barrel 40 between the ninth and tenth cylinders 72 and 73, the ninth and tenth cylinders operate to clamp an empty pen barrel 40 between the cylinders. Then, the swinging arm 71 rotates to position the clamped empty pen barrel 40 onto a jig 6 supported on the chain 5. The swinging arm 71 may both rotate and elevate in order to accommodate differences in height between the stock feeding area and the jigs 6. The photoelectric sensing device 86 may detect when an empty pen barrel 40 is positioned directly between the ninth and the tenth cylinder 72 and 73 so as to perform the clamping operation accurately.

While illustrative embodiments have been illustrated and described, it will be appreciated that various changes can be made therein without departing from the spirit and scope of the invention.

The embodiments of the invention in which an exclusive property or privilege is claimed are defined as follows:

1. An assembly line system, comprising:
a worktable;
a first sprocket positioned on a first side of the worktable and a second sprocket positioned on a second, opposite side of the worktable;
a chain connecting the two sprockets;
a plurality of jigs provided on the chain, wherein the jigs are configured to receive pen barrels; and
an ink-reservoir mounting station and an ink-reservoir pressing station provided on the worktable successively, wherein the ink-reservoir mounting station comprises an automatic ink-reservoir mounting machine, and the ink-reservoir pressing station comprises an automatic ink-reservoir pressing machine.

2. The assembly line system of claim 1, wherein the automatic ink-reservoir mounting machine and the automatic ink-reservoir pressing machine are provided on the same worktable.

3. The assembly line system of claim 1, wherein the automatic ink-reservoir mounting machine comprises a vibratory feeder that connects to an upright transporting pipe that feeds a pen barrel carried on a jig on the chain.

4. The assembly line system of claim 1, wherein the automatic ink-reservoir mounting machine comprises a loading jig that is horizontally positionable in a first position and in a second position, wherein the first position of the loading jig is below an upright transporting pipe, and wherein the second position is between a vertically movable shaft above and a jig on the chain below.

5. The assembly line system of claim 4, wherein the loading jig includes a hole that aligns beneath the transporting pipe in the first position, wherein the hole is aligned with and positioned between the vertically movable shaft and a jig on the chain.

6. The assembly line system of claim 4, wherein the loading jig is connected to a cylinder that moves the loading jig from the first position to the second position and returns the jig to the first position.

7. The assembly line system of claim 4, wherein the loading jig is configured to receive an ink reservoir from the transporting pipe in the first position, and wherein the movable shaft is configured to push the ink reservoir from the loading jig to a pen barrel carried by the jig on the chain in the second position.

8. The assembly line system of claim 1, wherein a feeding station and an ink-filling station are provided in succession on the worktable upstream of the ink-reservoir mounting station, and wherein a pen-cap mounting station, a pen-cap pressing station, and a cropping station are provided in succession on the worktable downstream of the ink-reservoir pressing station, wherein each station is provided along the same worktable and chain.

9. The assembly line system of claim 8, wherein the feeding station comprises an automatic feeding machine, wherein the ink-filling station comprises an automatic ink-filling machine, wherein the pen-cap pressing station comprises an automatic pen-cap pressing machine, and wherein the cropping station comprises an automatic cropping machine.

10. The assembly line system of claim 9, wherein the automatic cropping machine comprises a clamping assembly having a first cylinder with a first cylinder shaft, and a second cylinder with a second cylinder shaft, wherein the first and second cylinder shafts are facing each other, and wherein a space between the first and the second cylinder shafts is above a jig on the chain of the worktable.

11. The assembly line system of claim 10, wherein the clamping assembly is coupled to a third cylinder that is configured to move the clamping assembly from above the jigs to an area clear of the jigs.

12. The assembly line system of claim 9, wherein the sprockets, the automatic feeding machine, the automatic ink-filling machine, the automatic ink-reservoir mounting machine, the automatic ink-reservoir pressing machine, the automatic pen-cap pressing machine, and the automatic cropping machine are connected to a programmable logic controller (PLC) controlling module; and wherein the automatic feeding machine, the automatic ink-filling machine, the automatic ink-reservoir mounting machine, the automatic ink-reservoir pressing machine, the automatic pen-cap pressing machine, and the automatic cropping machine are each provided with a photoelectric sensing device.

13. The assembly line system of claim 1, wherein the plurality of jigs carries a plurality of fountain pens.
